(19) United States
(12) Patent Application Publication
(10) Pub. No.: US 2026/0279229 A1
(43) Pub. Date: Sep. 17, 2026

(54) A-Frame Brace

(71) Applicant: James Vitello, Escondido, CA (US)

(72) Inventor: James Vitello, Escondido, CA (US)

(21) Appl. No.: 19/562,559

(22) Filed: Mar. 10, 2026

Related U.S. Application Data
(60) Provisional application No. 63/770,710, filed on Mar. 12, 2025.

(51) Int. Cl. G09F 7/20; G09F 7/18

(52) U.S. Cl. CPC G09F 7/20; G09F 2007/1843

(57) ABSTRACT

A portable A-frame type merchandising sign has an adjustable locking mechanism for securing the frame. A center portion consisting of an interior and exterior sleeve where the elongated portion of the adjustable interior sleeve can slide in and out of the Exterior Sleeve and be locked in place by a particular locking method. The adjustable interior sleeve also comprises a support end block that acts as the resting spot for the leg portion of the A-frame. This adjustable feature increases the ability to display the A-frame in a wider variety of locations. The securing-of-the legs feature increases the stability of the A-frame when in its upright position.

### CROSS REFERENCE TO RELATED APPLICATIONS

This utility patent application claims priority back to U.S. Provisional No. 63/770,710, filed Mar. 12, 2025, the contents of which are incorporated by reference into this application.

### STATEMENT REGARDING FEDERALLY SPONSORED RESEARCH OR DEVELOPMENT

This invention was not federally sponsored.

### BACKGROUND OF THE INVENTION

### Field of the Invention

This invention relates to the general field of merchandising methods and more specifically to portable A-frame type sign displays.

### History of the Invention

A sandwich board, which became most popular in the 19th century, as a means of a portable advertisement platform, was composed of two boards each displaying, either the same or different, printed message and/or other picture or design, with one board in front and the other in back, hinged along the top by some fashion and forming a triangular, A-shaped, tent configuration allowing passers-by to read the boards on either side, from either direction.

It can be widely considered that there are two main types of this A-frame sandwich board configuration. A carried version, where the two boards are attached by straps along the top, allowing a person to slip between the two boards and support the weight of the boards on their shoulders and which is easily carried in a mobile fashion with one of the boards visible from the front and the other from the wearers back, thus allowing both sides of the advertisement to be easily read.

The second variety of the sandwich board, also commonly known as an “A-board” sandwich board, is not wearable by an individual and is constructed to be of a stand-alone type of advertisement. It is this second type that this invention is designed to work with.

This second design is also a portable sign, but is commonly used in a freestanding, stationary position, on sidewalks, street corners, or other areas that may be used as a convenient, yet temporary, place to advertise a business, product, service, or other item or idea anyone may wish to promote. It is perfect for drawing attention to the message advertised on the boards, especially in areas of significant foot traffic.

Though the advertisements themselves can vary widely, the frames for this second type are of a similar design. It is commonly used for real estate open house signs in many areas of the U.S. but is not limited to real estate open house signs and can be used by any business wishing to advertise using this method.

The main concept of this type of frame is that it can be folded, easily opened, closed, or moved. When closed this frame lays in a generally flat configuration. When open this frame generally forms an A-shaped “tent” configuration where-as the top is “hinged” together in some permanent manner and the bottom opens to form a wider base, of various distances, to add support and allow the frame/sign to stand.

Though this A-frame sign configuration is convenient and easy to use it does have some drawbacks that other more permanent, stationary, fixed types of advertisement (aka: billboards, side of building signage, etc.) don't have. One of these drawbacks is that when open at the base, due to their nature, the base must have a broad expansion, in proportional width, to support the upper portion of the frame and allow the marketing sign/message to stand in a relatively stable position, thus taking up a much wider “floor” space than what might be more favorable or desired. Often this characteristic can be detrimental in that the sign can become a trip hazard if placed in a pedestrian walkway or other trafficked area. This broad expansion of the base may also make the sign itself unusable if the desired placement area is not wide enough to accommodate the sign in the opened position. With this type of A-frame design if the base is not at a sufficient width the sign/frame itself may become unstable and collapse in upon itself and fall down/over. In addition, most A-frames do not have a locking method to hold the sign in its open position and may otherwise easily be knocked down if bumped, jarred, or wind/weather blown.

Any type of sandwich board can be constructed from various materials, including steel, wood, plastic, or other materials. The frame can be constructed where the two sides of the frame are comprised of the two actual boards that have the printed message/advertisement on them and in which these sides also act as the support for the frame itself.

In other designs the frame can consist merely of metal, or other material, rod-like construction and the advertisement board is hung, by some manner, from the hinged upper area of the frame and is balanced between the support portions of the frame. In this particular design generally only one board is used and each side of the board displays either the same or different messages, pictures, or designs.

These various types of A-frames, as well as being manufactured from various materials, can also be manufactured by various manufacturers with various leg, foot, or other structured designs that act as the base or “footing”. These base or footing designs can be similar to the bottom of a chair leg, an elongated cylindrical rod structure, or other design and with this leg portion of the frame base coming in contact with the ground, floor, or other surface that acts as the support for the frame to stand.

### Objects of the Invention

It is therefore an object of this present and new product, seeking patent protection, a very simple and easy method that allows the stationary A-frame to be stabilized, and braced, preventing it from easily being collapsed from most types of jarring, bumping, or wind/weather.

A further object of this invention is to assist in locking the base in a pre-determined width. It allows the width of the base of the A-Frame to be adjusted, and readjusted, if desired, to varying widths, including to a smaller width if placement of the sign will be in smaller area, then would allow the frame to be placed if the base was at a larger width, or in pedestrian walkway, street corner, etc. and still allow the sign to maintain its upright position.

Another object of this new device will also take into consideration the above-mentioned differences in the manufacture's designs of the “footings”, the portion of the frame that comes into direct contact with the ground or other surface that the signage is placed upon. This can be achieved by slight variations in the “support end block” portion of the inner sleeve whereas the end block can be interchanged with a different design but allowing the elongated portion of the adjustable center sleeve configuration to remain the same.

There has thus been outlined, rather broadly, the more important features of the invention in order that the detailed description thereof may be better understood, and in order that the present contribution to the art may be better appreciated. There are additional features of the invention that will be described hereinafter, and which will form the subject matter of the claims appended hereto. The features listed herein, and other features, aspects and advantages of the present invention will become better understood with reference to the following description and any appended claims. The accompanying drawings, which are incorporated in and constitute part of this specification, illustrate embodiments of the invention and, together with the description, serve to explain the principles of the invention.

It should be understood the while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE FIGURES

One preferred form of the invention will now be described with reference to the accompanying drawings. It is noted that the following figures are not drawn to scale.

FIG. 1 is a top, end, and side view of the Exterior Sleeve.

FIG. 2 is a depiction of the top, side, bottom, end, and angled view of the Adjustable Interior Sleeve with its Base Support End Block.

FIG. 3 shows the side, top/bottom (top is same as bottom), end, and angled view of the Crossbar.

FIG. 4 is a front, bottom, side, and angled view of the Crossbar-Support.

FIG. 5 shows one embodiment of the various Item numbers and their respective placement within the nature of the invention design and Complete Assembly 11.

FIG. 6 is one depiction of the Complete Assembly 11 in its respective position in regard to placement to one particular style of A-Frame 10, with a rod-like base/legs.

FIG. 7 is one depiction, similar to FIG. 6, but from a different view, of the Complete Assembly 11 and its respective position in regards to the A-Frame 10 style with a rod-like base/legs.

### DETAILED DESCRIPTION OF THE FIGURES

May aspects of the invention can be better understood with references made to the drawings below. The components in the drawings are not necessarily drawn to scale. Instead, emphasis is placed upon clearly illustrating the components of the present invention. Moreover, like referenced numerals designate corresponding parts through the several views in the drawings. Before explaining at least one embodiment of the invention, it is to be understood that the embodiments of the invention are not limited in their application to the details of construction and to the arrangement of the component set forth in the following description or illustrated in drawings. The embodiments of the invention are capable of being practiced and carried out in various ways. In addition, the phraseology and terminology employed herein are for the purpose of description and should not be regarded as limiting.

Moreover, all statements herein reciting principles, aspects, and embodiments of the present disclosure, as well as specific examples, are intended to encompass equivalents thereof.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “includes” and/or “including” when used herein, specify the presence of stated features or components but do not preclude the presence or addition of one or more other feature or component.

It should also be noted that in some alternative implementations, the functions/acts noted may occur out of the order noted in the figures.

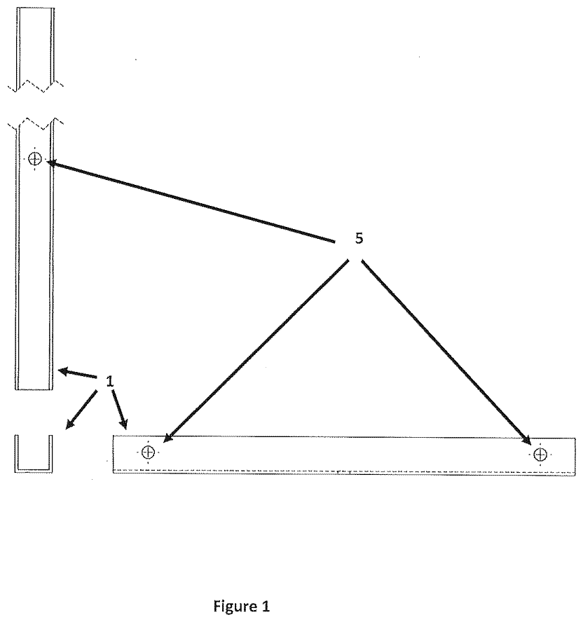

FIG. 1 is a top, front, and side view, of one rendition of the Exterior Sleeve 1. This Exterior Sleeve 1 serves as the main body of this invention and is of a hollow construction thus allowing the item Adjustable Interior Sleeve 2 to be housed within. This Exterior Sleeve 1 also serves as a mode of connecting a second, parallel, Exterior Sleeve 1 and its attachments, with the use of the Crossbar 3 and Crossbar-Support 4 thus forming the desired Complete Assembly 11, in full. The hollow design enables the Adjustable Interior Sleeve 2 to move freely in and out and back and forth inside this Exterior Sleeve 1. This Exterior Sleeve 1 can be made from aluminum, plastic, other metal, or other material and can vary in length. It can be of a u-channel, square, round, or other shape. This Exterior Sleeve 1 has, along its length, a number of Exterior Sleeve 1 side adjustment Through Holes 5. The Exterior Sleeve's 1 adjustment Through Holes 5 are located on opposite sides of the Exterior Sleeve 1 and allow the through placement of one or more securing screws or bolts and accompanying plurality of wing nuts or other style nuts. In this, shown, embodiment of FIG. 1 there are 2 Adjustment Through Holes 5. One near either end of the sleeve. However, the number of Adjustment Holes 5 can be 1,2, or more. When the Adjustable Interior Sleeve 2 is inserted into the Exterior Sleeve 1 the Adjustable Interior Sleeve 2, as previously mentioned, can move in and out, back and forth at which time a particular Adjustable Interior Sleeve 2 adjustment Through Hole 5 can be set to align with a particular Exterior Sleeve 1 adjustment Through Hole 5. When the desired placement of said holes align to accommodate the desired combined length of the Adjustable Interior Sleeve 2 and the Exterior Sleeve 1 a Securing Bolt/Screw 6 can be inserted through said aligned holes and secured using a Securing Wing Nut 7. It would be customary for the complete invention-Complete Assembly 11 to consist of two of these Exterior Sleeve 1/Adjustable Interior Sleeves 2 combinations, similarly attached, at the opposite end of the Crossbar 3. Thus, when secured, the footings of the A-frame itself can be placed within the two attached Support “End Block” portions of the Adjustable Interior Sleeve 2, and the desired width of the A-frame's 10 base can be achieved. In addition, each Exterior Sleeve 1 would have one Crossbar 3 securing Through Hole 5 located near the center of the Exterior Sleeve 1. It is at this point that the Crossbar 3 and the Crossbar-Support 4 will be attached.

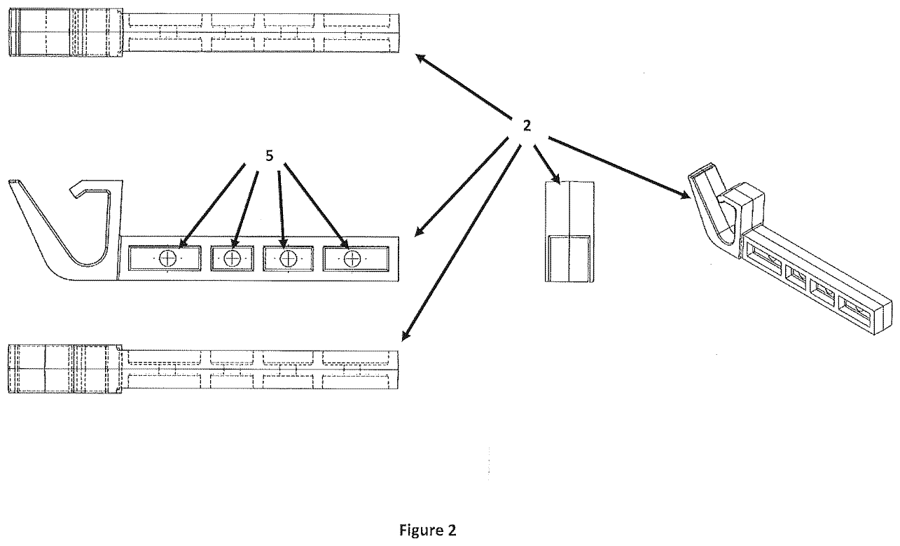

FIG. 2 is a top, side, bottom, end, and angled view depiction of one rendition of the Adjustable Interior Sleeve 2. This Adjustable Interior Sleeve 2 and its Base Support End Block portion acts as the anchor to which the support of the A-Frame's 10 base is achieved. The elongated portion of this Adjustable Interior Sleeve 2 is designed, and capable of moving in and out and back and forth through an Exterior Sleeve 1. The Adjustable Interior Sleeve 2 have the capability to be in a fixed, but adjustable, position within an Exterior Sleeve 1. This sleeve is one of two Adjustable Interior Sleeves 2 that will be used, in tandem, with each Exterior Sleeve 1 that is used. This Adjustable Interior Sleeve 2 can be made of plastic, metal, wood or other material and can vary in length and can be of a hollow or solid nature. It can be square, round or another shape. In this figure the Adjustable Interior Sleeve 2 shows 4 Adjustable Interior Sleeve 2 adjustment Through Holes 5. However, along the length of the Adjustable Interior Sleeve 2 there can be 1,2,3, 4 or more adjustable Through Holes 5 depending upon the length of the sleeve and/or the amount of adjustability desired for a particular embodiment of the invention. These adjustment Through Holes 5 can be equidistant from each other or have a variable distance between them. This desired adjustability may/or may not be determined by the type and/or size of the A-Frame 10 that will be supported and the embodiment of this invention that it will be manufactured for. When slid in and out of the Exterior Sleeve 1 these adjustment Through Holes 5 will align with a Exterior Sleeve 1 adjustment Through Hole 5 allowing a Securing Screw/Bolt 6, pin or other device to be passed through and secured by some type of Securing Wing Nut 7, thus securing the Adjustable Interior Sleeve 2 with the Exterior Sleeve 1 and acquiring the fixed, but temporary and adjustable, desired overall length of the invention. The Securing Wing Nut 7 also may be of another type of thumb nut or other style nut. In addition to the elongated portion of this Adjustable Interior Sleeve 2 there is an “End Block” portion that acts as the resting and placement spot for the base of the A-Frame 10. This “End Block” portion can vary in depth, height, and width and can have variations in its angles of construction or other construction designs depending upon which type of A-Frame and the A-Frames base that it may have.

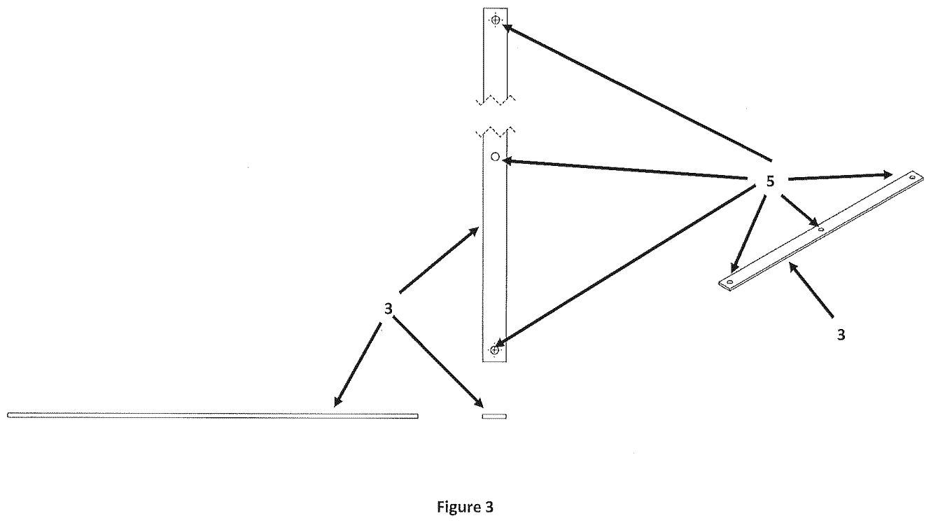

FIG. 3 shows the side, top/bottom (top is same as bottom), end, and angled view of the Crossbar 3. This Crossbar 3 is designed and capable of joining, securing, and stabilizing two, or more, Exterior Sleeves 1 together. Though it would be customary that only two Exterior Sleeves 1, working in tandem, would be sufficient for proper usage. In this rendition the Crossbar 3 is flat and relatively thin but can be of a round, square, or other shape and can vary in thickness and width. It can be made of aluminum, other metal, plastic, wood, or other material. This Crossbar 3 consists of two Cross Bar securing Through Holes 5, one hole each, located at or near either end of the Crossbar 3. These Through Holes 5 will be the attachment point, using a Securing Bolt/Screw 6 and Securing Wing Nut 7, to the center of the Exterior Sleeve 1 and the Crossbar-Support 4. The one Exterior Sleeve 1 and 2 Adjustable Interior Sleeves 2 assembly can thus be attached at either end of the Crossbar 3. In addition, this Crossbar 3 can have one, or more, binding post Through Hole 5 located near the center, or other placement, of the Crossbar 3. This center, or other located, binding post Through Hole 5 is an optional hole where a binding post, or other screw/bolt and nut assembly can be passed through and secured. It is at this point that an optional chain, or other apparatus, can be secured along with said Binding Post/Bolt 8 & Securing Nut 9 and optional lock and secured to one or more legs of the A-Frame to serve as an anti-theft deterrent. This optional chain addition would have no overall bearing on the functionality of the inventions intended use.

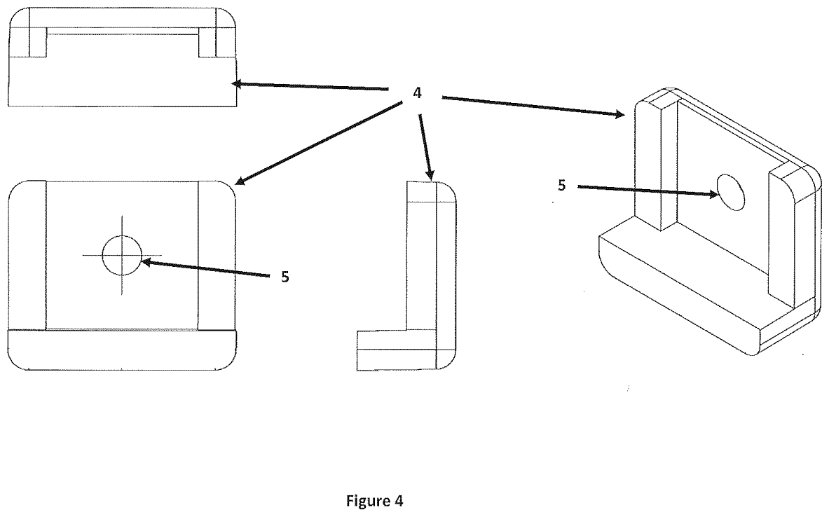

FIG. 4 is a front, bottom, side, and angled view of the Crossbar-Support 4. The Crossbar-Support 4 can be made of plastic, metal, wood, or another material. This Crossbar-Support 4 is designed to be used, in tandem, with the Crossbar 3. It can vary in size and shape but is sized in correlation to the width and thickness of the Crossbar 3 that it will be used with. The Crossbar-Support 4 has two smaller lip extensions, one at each side, that will allow the Crossbar 3 to slide between and act as a stabilizer feature for the Crossbar 3, restricting turning movement. In addition, it has a third, wider lip, that when placed upon the Exterior Sleeve 1 it abuts to the Exterior Sleeve's 1 outer side and acts as a stabilizing feature for the Exterior Sleeve 1, restricting turning movement. The Crossbar-Support 4 also has a Through Hole 5. When this Through Hole 5 aligns with the Crossbar's 3 end Through Hole 5 and the Exterior Sleeve's 1 center top Through Hole 5 it allows a Securing Bolt/Screw 6 to be placed through and secured using Securing Wing Nut 7 or some other type of nut fastener, thus stabilizing the Complete Assembly 11.

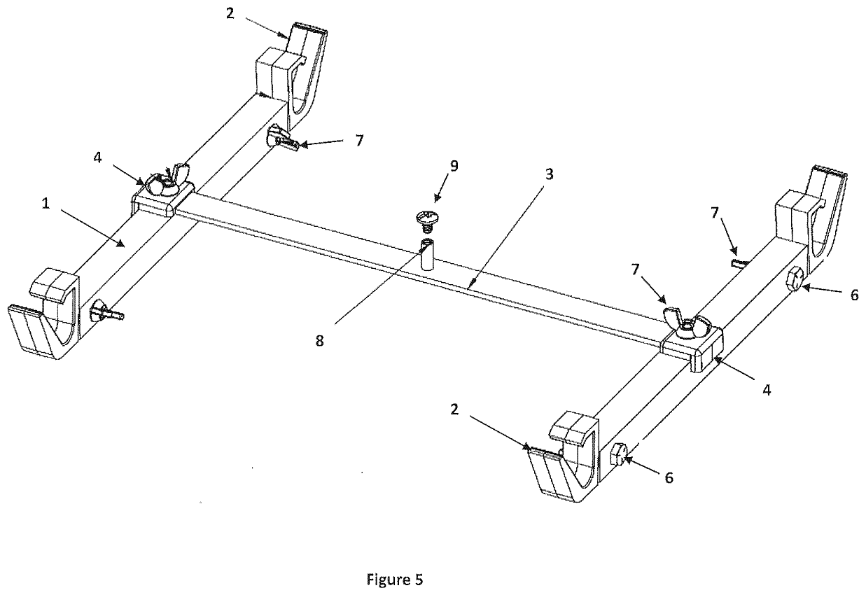

FIG. 5 shows one embodiment of the various Item numbers and their respective placement within the nature of the invention design. In this figure it shows the elongated portions of the 4 Adjustable Interior Sleeves 2, 2 each, slid fully into the cavity of two Exterior Sleeves 1 and secured by a Securing Bolt/Screw 6 and Securing Wing Nut 7. Thus, leaving the Support End Block portion of the Adjustable Sleeve 2 directly abutting the ends of the Exterior Sleeve 1. In this configuration the Complete Assembly 11 is in its most compact configuration and the A-Frame's 10 base would be at its smallest adjustable width. The Adjustable Interior Sleeve 2, would however, have the capacity to slide further out, secured, and form a wider configuration. This figure also illustrates the alignment of the Crossbar 3 and the Crossbar-Support 4 as they are placed atop of, and overlapping of the side, of the Exterior Sleeve 1, and secured by a Securing bolt/Screw 6 and Securing Wing Nut 7 combination. Furthermore, this figure shows the optional placement of a binding post, or bolt/screw and nut, in the center Through Hole 5 of the Crossbar 3, which-in-turn would allow the optional attachment of a chain-like addition that can be wrapped around the A-Frame's base or leg and then can be secured by lock, or other means, adding an additional anti-theft deterrent.

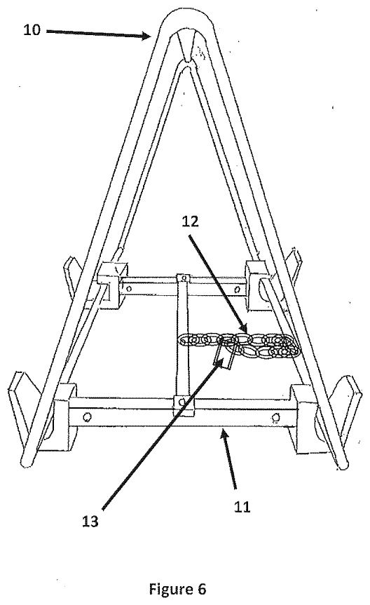

FIG. 6 is one depiction of the Complete Assembly 11 in its respective position in regards to placement with one style of A-Frame 11 with a rod-like base. This figure illustrates, the A-Frame adjusted to its smallest width position and how the rod-like base of the A-Frame would be situated in the Adjustable Interior Sleeve's 2 “End Block” portion. This figure also shows the possible placement of a Chain 12 which can be wrapped around the A-Frame's base leg and locked together by an additional Lock 13 to be used as an anti-theft deterrent.

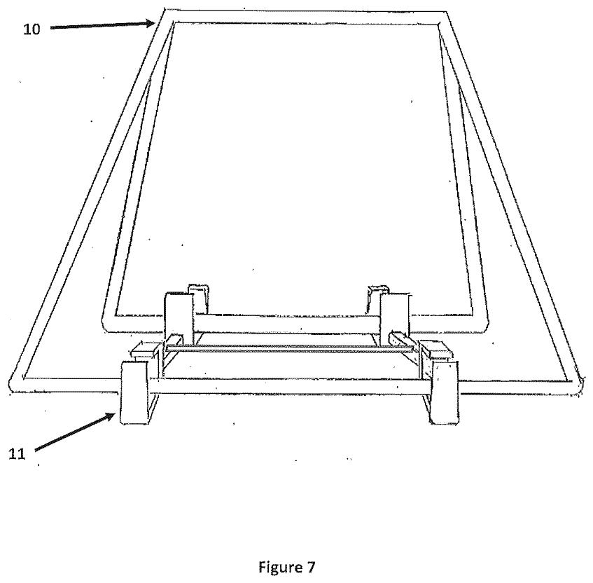

FIG. 7 is similar to FIG. 6 but with the depiction of the Complete Assembly 11 in its respective position in regards to placement with one style of A-Frame 10, with a rod-like base, from a different perspective.

### Reference Numbers Used

#1 Exterior Sleeve
#2 Adjustable Interior Sleeve with Base Support End Block
#3 Crossbar
#4 Crossbar-Support
#5 Through Hole
#6 Securing Bolt/Screw
#7 Securing Wing Nut
#8 Crossbar 3 Binding Post/Bolt
#9 Crossbar 3 Binding Post/Securing Nut
#10 A-Frame with Rod-Like Base
#11 Complete Assembly
#12 Chain
#13 Lock

That which is claimed:

1. An adjustable support and locking device, for use with an A-Frame type sign holder, consisting of two Exterior Sleeves as part of an Assembly.

2. The adjustable support and locking device of claim 1, where two Adjustable Interior Sleeves are added to each of the two Exterior Sleeves, and each of the two adjustable interior sleeves are inserted into each end of the two Exterior Sleeves.

3. The adjustable support and locking device of claim 2, where each Adjustable Interior Sleeve consists of an elongated portion and one Support End Block portion.

4. The adjustable support and locking device of claim 3, where the End Block portion of the Adjustable Interior Sleeve acts as the placement and resting spot for a leg and a base portion of the A-Frame type sign holder.

5. The adjustable support and locking device of claim 4, where the elongated portion of the Adjustable Interior Sleeve can slide in and out and back and forth in an Exterior Sleeve.

6. The adjustable support and locking device of claim 5, where the Adjustable Interior Sleeves are in a fixed, but temporary and adjustable, position within the Exterior Sleeve.

7. The adjustable support and locking device of claim 6, where a Crossbar is added to the assembly.

8. The adjustable support and locking device of claim 7, where a number of Crossbar-Supports are added to the assembly.

9. The adjustable support and locking device of claim 7, where a Crossbar Support is placed over the end of the Crossbar and the top portion of the Exterior Sleeve.

10. The adjustable support and locking device of claim 9, where, when secured, the Crossbar Support, in conjunction with the Crossbar, acts as a stabilizing means to prevent and limit the turning and movement of the attached Exterior Sleeve and Adjustable Interior Sleeve portions of the assembly.

11. The adjustable support and locking device of claim 10, where an additional chain component can be attached to and secured to the Crossbar center through a Hole.

12. The adjustable support and locking device of claim 11, where an additional lock can be added to the chain component and secured around the base of the A-Frame type sign holder as an anti-theft deterrent.

13. An adjustable support and locking device, for use with an A-Frame type sign holder, comprising two Exterior Sleeves as part of an Assembly, where two Adjustable Interior Sleeves are added to each of the two Exterior Sleeves.

14. The adjustable support and locking device of claim 13, wherein each of the two adjustable interior sleeves are inserted into each end of the two Exterior Sleeves, where each Adjustable Interior Sleeve consists of an elongated portion and one Support End Block portion.

15. The adjustable support and locking device of claim 14, where the End Block portion of the Adjustable Interior Sleeve acts as the placement and resting spot for a leg and a base portion of the A-Frame type sign holder.

16. The adjustable support and locking device of claim 15, where the elongated portion of the Adjustable Interior Sleeve can slide in and out and back and forth in an Exterior Sleeve.

17. The adjustable support and locking device of claim 16, where the Adjustable Interior Sleeves are in a fixed, but temporary and adjustable, position within the Exterior Sleeve.

18. The adjustable support and locking device of claim 17, where a Crossbar is added to the assembly.

19. The adjustable support and locking device of claim 18, where a number of Crossbar-Supports are added to the assembly.

20. The adjustable support and locking device of claim 17, where a Crossbar Support is placed over the end of the Crossbar and the top portion of the Exterior Sleeve.
